(19) United States
(12) Patent Application Publication
(10) Pub. No.: US 2004/0071880 A1
(43) Pub. Date: Apr. 15, 2004

(54) Method of plating on surface of plastic post to printing

(75) Inventor: Tony Su, Taoyuan (TW)

Correspondence Address: Dorsey & Whitney LLP, Four Embarcadero Center, Suite 3400, San Francisco, CA, 94111-4187, US

(73) Assignee: MIN AIK COLOR PLATING CO. LTD.

(21) Appl. No.: 10/269,374

(22) Filed: Oct. 10, 2002

(51) Int. Cl. B05D 1/36; B05D 3/04

(52) U.S. Cl. 427/258; 427/402; 427/304

(57) ABSTRACT

A printing-plating process on a plastic surface is disclosed, wherein a acid- and alkaline-resist ink is printed on the surface of plastic to be processed prior to the procedure of plating, such that the printed patterns pertain the property of worn-proof and high adherence.

### FIELD OF THE INVENTION

The present application relates to a method for processing the surface of plastic, particularly to a method of plating on surface of plastic post to printing.

### BACKGROUND OF THE INVENTION

Due to the property of being capable of molding, plastic has been wildly used in various fields, particularly in the fields of electronic devices such as portable phones, personal digital assistance (PDA) and the like. To enhance the quality image of the devices, it has become a popular technique to provide the electronic devices with a metallic surface. Conventionally, painting process, i.e., providing painting and heating on the surface of molded plastic case with metallic paint having miniature grain, is utilized to render an effect of metallic surface on the plastic case. However the paint layer provided on the surface of the plastic case will be unavoidably worn out after a period of usage, no matter how thick the paint layer is, and thereby the original color of the plastic case will be exposed and the quality of the plastic case is deteriorated.

An prior art plating process of plastic surface for improving the durability of the above mentioned painting process is known. The prior art plating process of plastic surface comprises the pre-process steps of de-oil cleansing, washing, roughing, washing, neutralization, activation, and the process of plating. After the plating process, the object is transmitted to the subsequent stages for pattern printing.

The above prior art plastic plating and printing process has a main problem, that is, the surface of the plastic object become smooth and glossy, which lowers the adherence for the printing ink. Therefore the ink printed on the plated surface tends to be worn out or peeled off after a period time of usage.

### SUMMARY OF THE INVENTION

Aiming to the above problem in the prior art, the present application provides a plating process on plastic surface post to printing, which provides a significant adherence for the ink to adhere on the plastic surface.

One object of the present application is to provide a plating process on plastic surface post to printing, which is applicable to the surface of transparent plastic material.

Another object of the present application is to provide a plating process on plastic surface post to printing, which is applicable to the surface to non-transparent plastic material.

A further object of the present application is to provide a plating process on plastic surface post to printing, which makes the thickness of printed portion and non-printed portion identical.

Another further object of the present application is to provide a plating process on plastic surface post to printing, in which the printed ink is protected by the plated metal layer.

### BRIEF DESCRIPTION OF THE DRAWINGS

FIG. 1 is a flow chart of a first embodiment of the plating process on plastic surface post to printing according to the present application.

FIG. 2 is a flow chart of a second embodiment of the plating process on plastic surface post to printing according to the present application.

### DETAILED DESCRIPTION OF THE PREFERRED EMBODIMENT

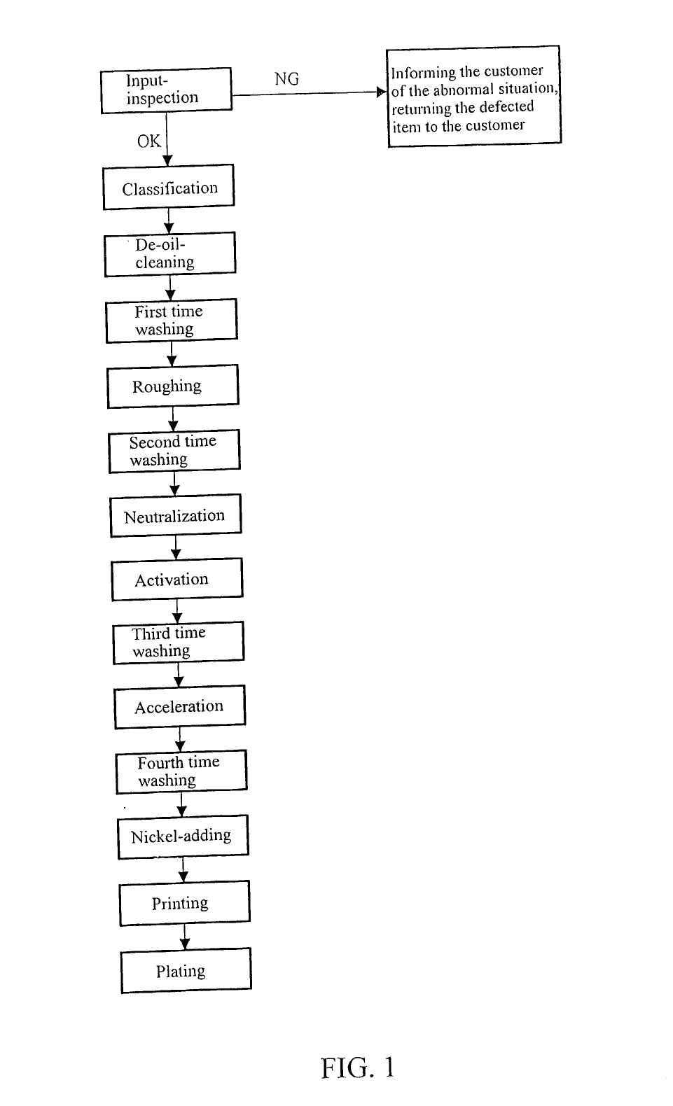

FIG. 1 is a flow chart of a first embodiment of the plating process on plastic surface post to printing according to the present application. As shown in FIG. 1, the process of this embodiment starts with step of input-inspection. The input and quality control unit manually inspects the appearance of the raw material of the item to be processed. If an unqualified item is found, the input and quality control unit informs the customer of the abnormal situation, registers the abnormal situation on the list, and returns the defected item to the customer. If the result of the inspection is normal, the process then moves on to the next step “classification and hanging”.

In the step of classification and hanging, the items to be processed are hung on various hangers according to their respective property such as the hardness of the material, weight and size. The process then moves on to the next step “de-oil-cleansing”.

In the de-oil-cleansing step, the items to be processed are soaked in processing liquid of temperature 35 to 55° C. and concentration 15 to 25 BM for about 3 to 10 minutes, so as to remove the stains and oil from the surface of the plastic items. The process then moves on to the next step “first time washing”.

In the first washing step, the items to be processed are subject to rinse with circulating soft water for 2 to 3 times, such that the processing liquid of the previous step which remains on the surface of the items is removed. The process then moves to the next step “roughing”.

The purpose of the roughing step is to increase the roughness of the surface of the plastic so as to increase the adherence force of the surface of the plastic to a predetermined level. In the roughing step, the items are subject to soaking in roughing agent of temperature 65 to 75° C. and concentration 40 to 50 BM for 3 to 10 minutes. After the above roughing step is completed, the process then moves on to the next step “second time washing”.

In the second time washing step, the items to be processed are subject to rinse with circulating soft water for 2 to 3 times, such that the roughing agent of the previous step which remains on the surface of the items is removed. The process then moves to the next step “neutralization”.

In the neutralization step, the items to be processed are subject to soaking in alkaline agent of temperature 40 to 50° C. and concentration 10 to 20 BM for 3 to 8 minutes. The purpose of this neutralization is to neutralize the acid surroundings caused in the previous roughing step. The process then moves on to the next step “activation”.

In this activation step, the surface of the processed items is immersed in the solution containing Palladium-Tin alloy. The solution containing Palladium-Tin alloy is of the temperature 40 to 55° C. and concentration 10 to 20 BM, and the process time is 2 to 6 minutes. The purpose of the activation step is to cover a layer of Palladium-Tin alloy on the roughened surface of the processed items. Since the surface of the processed items has been subjected to the roughing process such that a plurality of predetermined sized caves are formed on the surface, the Palladium-Tin alloy is able to adhere on the surface of the processed items. The process then moves to the next step “Third time washing”.

Similar to the previous washing steps, the items to be processed are subject to rinse with circulating soft water for 2 to 3 times, such that the alloy-containing solution of the previous step which remains on the surface of the items is removed. The process then moves to the next step “acceleration”.

In the acceleration step, the processed items are immersed in the acceleration agent in the temperature of 45 to 55° C. and of concentration 8 to 15 BM for about 2 to 6 minutes, so as to remove Tin from Palladium-Tin alloy adhered on the surface of the processed items and leave only Palladium thereon. After this acceleration step, Palladium substantially distributes on the surface of the processed items in the form of plural singular points. The process then moves on to the next step “fourth time washing”.

Similar to the previous washing steps, the items to be processed are subject to rinse with circulating soft water for 2 to 3 times, such that the acceleration agent of the previous step which remains on the surface of the items is removed. The process then moves to the next step “Nickel-adding”.

In this Nickel-adding step, the processed items are immersed in the Nickel-adding agent in the temperature of 35 to 45° C. and of concentration 15 to 20 BM for about 3 to 8 minutes. The purpose of this acceleration step is to bridge the Nickel metal between the point-distributed metal Palladium, so as to convert the Palladium-only point metal distribution into a plain metal-distribution. The steps from classification and hanging to Nickel-adding are referred to as pre-process for plating on plastic surface. Since plastic is a non-conductive material, it is necessary to coal a metal film on the surface of the plastic items before the process of plating. After the step of Nickel-adding, the process then moves on to the next step “printing”.

In the printing step, desired patterns are printed on the surface of the processed items with lithographic method, screen printing method or other printing method using predetermined ink. The predetermined ink has the property of acid and alkaline corrosion-resistance. Further the ink is able to tightly adhere on the surface. After a period of 5 to 10 minutes, the ink solidifies and then the step moves on to the next step “plating”.

In the plating process, the electrode is attached on one end of the processed item, which is soaked in the electrolyte, while the plating metal is attached to the other electrode and is soaked in the same electrolyte. Both electrodes are connected to the power source to proceed with plating. Since the surface of the processed items has been covered with a film of metal, the metal to be plated thereon is able to evenly form on the film of metal. Time for plating depends on the desired thickness of plating. The longer the plating time, the thicker the film of plating. As described above, the peripheral edges of the printed patterns are surrounded by the plating metal, the thickness of the metal film and the thickness of the printed pattern are substantially the same, therefore the printed patterns and the upper surface of the plating metal film are substantially on the same plain.

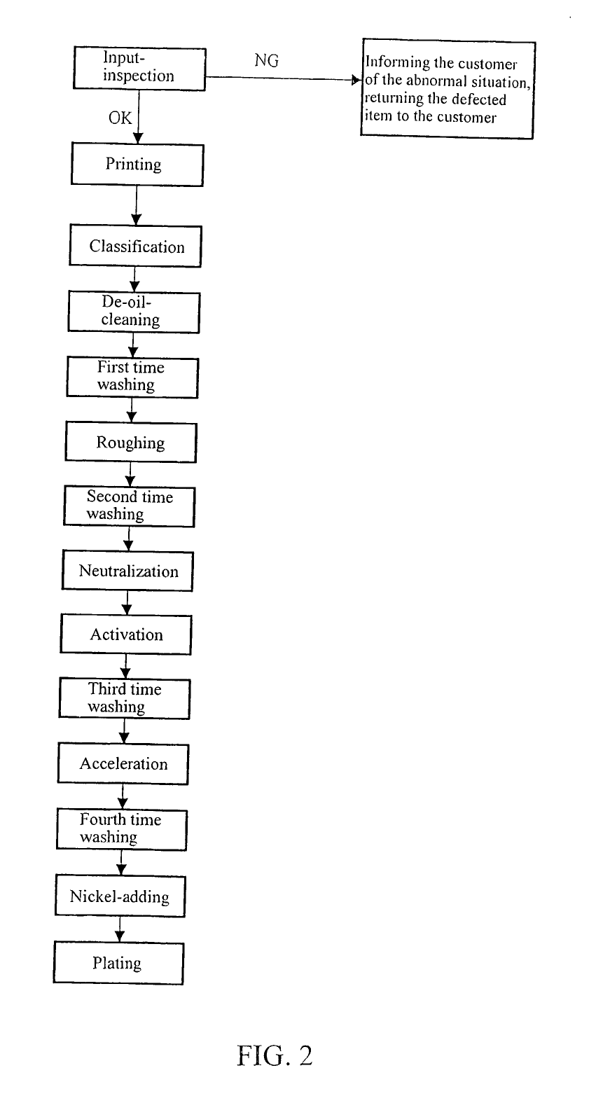

FIG. 2 is a flow chart of a second embodiment of the plating process on plastic surface post to printing according to the present application. Except that the material adopted and the sequence of the printing step, the second embodiment is substantially the same as the first embodiment. In the first embodiment non-transparent plastic materials such as PC, PC plus ABS, PP or Nylon are used. In the second embodiment, transparent plastic materials such as transparent PC or transparent ABS are used. Similarly, ink used in the second embodiment must be transparent and acid-, alkaline-resistant. In addition, the printing step is set between step “input and inspection” and step “classification and hanging”.

Except the above mention parts, the first embodiment and the second embodiment are identical and therefore the description for those identical parts will not be repeated.

According to the above embodiments, the plating layer contacts and tightly surrounds the peripheral edges of the printed patters, so as to prevent the edges of the printed patterns from exposure. In the conventional process for plating on surface of plastic, the patterns are printed on the upper surface of the plating metal, which results in that the edges of the printed patterns are totally exposed to the outside contact. After a period of usage and a large amount of contacts, the edges of the printed patterns begin to peel off, eventually the whole patterns worn out. Since the product of the present invention provide a printed pattern whose peripheral edges are tightly surrounded by the plating metal film, the possibility for the printed patterns to peel off is significantly reduced.

1. A method of plating on surface of plastic post to printing, the method comprising the following steps in order:
selecting a non-transparent plastic material;
providing said plastic material with a pre-process of metal film covering;
printing desired patterns on the plastic material with ink; and
providing said plastic material with plating process.

2. The method according to claim 1, wherein the non-transparent plastic material is chosen from the group consisting of PC, ABS, PC plus ABS, and Nylon.

3. The method according to claim 1, wherein said ink is acid-resistant and alkaline-resistant.

4. A method of plating on surface of plastic post to printing, the method comprising the following steps in order:
selecting a transparent plastic material;
printing desired patterns on the plastic material with ink;
providing said plastic material with a pre-process of metal film covering; and
providing said plastic material with plating process.

5. The method according to claim 4, wherein the transparent plastic material is chosen from the group consisting of transparent PC and transparent ABS.

6. The method according to claim 4, wherein said ink is acid-resistant and alkaline-resistant.
